(19) United States
(12) Patent Application Publication
(10) Pub. No.: US 2014/0093695 A1
(43) Pub. Date: Apr. 3, 2014

(54) PADDED LAYER ARRANGEMENT FOR PADDED BODY PROTECTION AND METHOD FOR THE PRODUCTION THEREOF

(71) Applicant: Julian Botsch, Fischbachau (DE)

(72) Inventor: Julian Botsch, Fischbachau (DE)

(21) Appl. No.: 14/115,437

(22) PCT Filed: Apr. 24, 2012
(86) PCT No.: PCT/DE12/00418

§ 371 Date: Nov. 4, 2013

(30) Foreign Application Priority Data
May 5, 2011 (DE) 10 2011 100 642.0

(51) Int. Cl. B32B 3/30; B32B 5/16; B32B 3/04

(52) U.S. Cl. CPC B32B 3/30; B32B 3/04; B32B 5/16
USPC 428/166; 156/276; 156/87

(57) ABSTRACT

A padded layer arrangement (01) and a method for the production thereof are provided. The padded layer arrangement (01) includes a plurality of hollow bodies (05), which are filled with elastic shaped particles and which are formed in a layer composite between a thermoplastically deformable base layer (03) and a thermoplastically deformable cover layer (02). In order to achieve a particularly cost-effective design, the base layer (03) is formed as a pocket-shaped protuberance (07) and, in the same orientation, the overlying cover layer (02) is formed with a projection (08) that extends into the protuberance (07) in order to form an individual hollow body (05).

### CROSS REFERENCE TO RELATED APPLICATIONS

This application is a United States National Phase Application of International Application PCT/DE2012/000418 filed Apr. 24, 2012 and claims the benefit of priority under 35 U.S.C. §119 of DE 10 2011 100 642.0 filed May 5, 2011, the entire contents of which are incorporated herein by reference.

### FIELD OF THE INVENTION

The invention relates to a method for the production of a padded layer arrangement for a padded body protection and relates to a padded layer arrangement according.

### BACKGROUND OF THE INVENTION

Padded layer arrangements of the type mentioned at the beginning are used for the production of padded body protection elements, such as those integrated in protective helmets or in functional sportswear. Here, the protective function is essentially based on absorbing blows or shocks by means of the shaped particle fillings that are formed in hollow bodies of the padded layer arrangement.

For attaining the best absorbing capacity possible, the aim is a packing density as high as possible of the shaped particles in the shaped particle package. This can be achieved, amongst other things, in that the hollow bodies are evacuated by means of an evacuation device and in that in this way, by means of the vacuum, a dense package is developed. Here, a dimensional stability is created at the same time such that, after the evacuation, the protective element has a mostly fixed shape, independently of the dimensional stability of the plastic casing.

The vacuum-related effect presumes that either valve devices suitable for a temporary evacuation have to be formed at the padded layer arrangement, or the padded layer arrangement is formed in a correspondingly complex manner, in the case of a permanent evacuation, in order to ensure that the vacuum is maintained for the lifespan of the padded layer arrangement.

### SUMMARY OF THE INVENTION

Therefore, it is an object of the present invention to provide a padded layer arrangement for a body protection element which can both be easily handled and easily produced.

The present object is attained by a method according to the invention as well as by a padded layer arrangement according to the invention.

With the method according to the invention, initially a plurality of pocket-shaped protuberances is formed in the base layer. Here, it is irrelevant whether the base layer initially is a completely flat layer that is stiff in itself or whether it is present in the form of a flexible and untensioned structure. At the very least, in the first step, the corresponding reshaping for forming the protuberances is effected.

For filling the pocket-shaped protuberances, the elastic shaped particles are filled in as a loose bulk. The shaped particles can be deformed at least in an elastic or semi-elastic and elastic-plastic manner. For instance, plastic balls made of polystyrene or of a similar material can be used.

Subsequently, a cover layer is applied onto the base layer. In this case, in the area of filling openings, which have been developed beforehand as a result of the formation of the pocket-shaped protuberances, the cover layer covers the base layer such that the shaped particle fillings and the filling openings are surrounded.

Consecutively, a temperature is applied to the cover layer that is arranged on the base layer and a vacuum is applied to the hollow spaces. The vacuum formed in the hollow spaces results in a compression of the loose bulk of shaped particles that is present in the hollow spaces. In this way, the space occupied by the shaped particle filling is reduced. Simultaneously with compressing the shaped particle filling, a deep-drawing of the cover layer onto the shaped particle filling is effected. Corresponding to the deformation of the cover layer, projections that extend into the protuberance are developed. This means that, corresponding to the pocket-shaped protuberances, projections are formed that are smaller in each case as well as in the same orientation. Furthermore, at the same time or subsequently, a joining connection is created in a connection zone that is formed at the upper edge of the pocket-shaped protuberance between the base layer and the cover layer. In this case, a permanent connection between the base layer and the cover layer is developed. The joining connection can be formed in a gas-tight manner, depending on the configuration.

The method according to the invention makes it possible in a particularly easy and cost-effective manner to produce a padded layer arrangement which has the advantageous shock-absorbing features without requiring the formation of the vacuum within the hollow bodies. It is only required to generate a vacuum in the production process in order to achieve a high packing density of the shaped particle filling or even an elastic pre-tensioning of the shaped particle filling by reducing the size of the hollow body interior.

With respect to the connection of the cover layer to the base layer in the connection zone, the precise embodiment of the joining connection is initially irrelevant. In a particularly advantageous embodiment, the joining connection is, however, produced by circumferentially welding the base layer to the cover layer, wherein a substantially gas-tight connection between the base layer and the cover layer is created.

It is particularly advantageous if, for forming the pocket-shaped protuberances, the base layer is initially put to rest on a mold plate with pocket-shaped mold cavities. In this case, the base layer can be both an element that is stiff in itself and an unstable element. At least, the base layer, which has been heated to deformation temperature, is pulled down into the mold cavities owing to a vacuum applied in the same. In this case, it is initially irrelevant how the deformation temperature is generated. On the one hand, it is possible to preliminarily heat the base layer externally and to apply the same at the elevated temperature. It is, however, advantageous to heat the base layer after applying it onto the mold plate. This can be done before applying or simultaneously with applying the vacuum. In this case, the heating can be effected both by means of a contact heater and by means of a radiation heater.

It is particularly advantageous if the base layer is configured to be gas-tight. Then, it can be configured as a plastic film. In this way, it is made possible in a simple manner to apply the vacuum in the mold cavities, without additional auxiliary means being necessarily required.

Alternatively, it is also possible to use, as the base layer, a layer that is not gas-tight initially, for instance a textile synthetic structure. For enabling a reshaping by means of a vacuum, here, the base layer can be covered by an additional gas-tight layer. It is obvious that, in this case, the additional layer has to present the necessary thermal stability for reshaping the base layer and the necessary deformability for forming the pocket-shaped protuberances.

Additionally or alternatively to using a vacuum for forming the pocket-shaped protuberances from the base layer, there is also the possibility to generate an overpressure on the upper side of the base layer, that is, when using a vacuum, on the side of the base layer facing the vacuum. In this case, in a simple manner, compressed air can be used which, in a production site, is usually available more easily as an auxiliary means than a vacuum to be generated. It is self-evident that a substantially sealing casing above the base layer is required in order to be able to generate the advantageous overpressure. What is not required is a complete gas-tightness. Thus, for instance, an upper-side tool for heating the base layer can be configured in such a manner that an overpressure between said tool and the base layer can be generated above the mold cavities. The required reshaping of the base layer is effected due to the pressure difference between the pressure above the base layer and the pressure within the mold cavities below the base layer. Correspondingly, using a vacuum within the mold cavities results in a reshaping having the same effect as using an overpressure above the base layer.

When using a base layer that is not gas-tight, however, a deformation by means of a stamping tool is particularly suitable, wherein the base layer is pressed down into the corresponding mold cavities by a heated mold stamp.

It is particularly advantageous if, for forming the projections of the cover layer that extend into the protuberance, a vacuum is applied to the hollow spaces which are defined by the base layer being covered by the cover layer via a bottom opening that is formed in a bottom wall of the protuberance.

The type of the bottom opening is initially irrelevant. In the case of a base layer that is not gas-tight, said bottom opening is directly given due to the missing gas-tightness.

When using a gas-tight base layer, the bottom opening is formed in a particularly advantageous way by means of a perforation of the bottom wall that rests against the mold cavity bottom. In this case, in a particularly advantageous way, a tool is used which is inserted into the deaeration opening of the mold plate. In this respect, the perforation of the base layer is effected from the side of the mold plate through the deaeration opening while producing the bottom opening.

In this case, it is irrelevant whether the perforation is generated while the vacuum is applied in the deaeration opening or whether initially, the perforation is carried out and subsequently, the vacuum is applied. At least, in an advantageous way, the tool is inserted into the deaeration opening for the purpose of the perforation.

For producing the projections that extend into the protuberance by means of a vacuum, a gas-tight seal is required on the upper side. This is realized in a particularly advantageous way by a gas-tight cover layer. In this respect, the cover layer can also be selected to be a regular cost-effective thermoplastic film.

Alternatively, it is possible to select the cover layer to be a thermoplastically deformable layer, too, which is, however, not configured to be gas-tight. For generating the required gas-tightness, for the purpose of the vacuum application, the cover layer is advantageously covered from the rear by another gas-tight layer. In this case, the additional gas-tight layer is required to be flexible in order to enable the deformation starting from the non-deformed cover layer for forming the projections that extend thereinto.

In an advantageous way, the application of temperature to the cover layer or to the layer that covers the cover layer is effected by means of a contact heater. Here, in a first embodiment, the cover layer can be put to rest on a flat heated tool. After becoming soft, by means of the vacuum, the projections can be formed. It is also possible to adapt the type of tool selected for heating the cover layer to the formation of the projections. In this respect, those areas of the cover layer are initially heated which are primarily deformed. In this case, in an advantageous way, the heating can be carried out continuously while the cover layer is reshaped.

Alternatively to the contact heater, in a particularly advantageous way, the application of temperature to the cover layer or to the gas-tight layer that covers the cover layer can be effected by means of a radiation heater. Due to using a radiation heater, it is not required to produce another mold tool. Furthermore, this embodiment has particular advantages since, triggered by the vacuum, the heating of the cover layer by means of the radiation heater can unabatedly be carried out during the deformation process. In this case, the radiation heater can carry out a regular radiation of the entire surface of the cover layer with the most simple embodiment. However, it is particularly advantageous if the radiation heater provides a variably distributed radiation energy corresponding to the shapes and the distribution of the protuberances and thus, of the projections to be produced. In this respect, particularly the areas to be deformed can be heated, whereas areas that are not to be deformed are subjected to a smaller temperature load.

Furthermore, it is advantageous if, before or after, particularly advantageously during application of the vacuum, such a tool is used which simultaneously produces the joining connection between the base layer and the cover layer in the connection zone in the upper edge surrounding the pocket-shaped protuberances. In this regard, it is advantageous if the means for generating the heating of the cover layer can be used at the same time for producing the joining connection.

According to the invention, the padded layer arrangement comprises a plurality of hollow bodies, which are formed in a layer composite between a thermoplastically deformable base layer and a thermoplastically deformable cover layer and which have a body casing that is formed by a base layer area and by a cover layer area, which are connected to each other via a joining connection in a connection zone that is circumferential in the plane of the layer composite, said connection zone forming an upper edge of a pocket-shaped protuberance of the base layer area, wherein the body casing has a shaped particle filling consisting of a plurality of elastic shaped particles and, for compressing the shaped particle filling, in the cover layer area, a projection is formed that extends into the protuberance.

In principle, a plurality of hollow bodies is envisaged which are formed in a layer composite between a thermoplastically deformable base layer and a thermoplastically deformable cover layer. Although the padded layer arrangement could also simply comprise a single hollow body for attaining the advantages according to the invention, an embodiment with a plurality of hollow bodies is preferred.

An essential feature of the padded layer arrangement according to the invention is that, for compressing the shaped particle filling or the loose bulk of elastic shaped particles, the cover layer area is formed as a projection that extends into the protuberance.

The padded layer arrangement according to the invention is in particular characterized by the particularly simple manner of production, which includes that the projections are formed in the same orientation as the protuberances. Due to this embodiment, a particularly dense packing of the shaped particles can be achieved and thus, the best possible protection level is achieved without an application of an additional vacuum being additionally required, as is usual in the state of the art.

Furthermore, the padded layer arrangement is suitable to be used in a variety of fields of application. Thus, the padded layer arrangement can be used for very different purposes, for instance for body protection or for protection of items during transport. It is also possible, for an individual use, to deform the padded layer arrangement again in the area outside the hollow bodies by means of below-described process steps due to the thermoplastically deformable base and cover layers.

It is particularly advantageous if the body casing has an opening. In an advantageous way, the opening is formed as a bottom opening in a bottom wall of the pocket-shaped protuberance here. It is obvious that in this way, when using the padded layer arrangement in the hollow body, no vacuum is applied. Nonetheless, the padded layer arrangement has the particularly advantageous dense packing which is necessary for attaining a high protection level. However, due to the missing vacuum, a manual reshaping after a deformation is made possible by a shock-like load. On the other hand, in the state of the art, it is required to remove the vacuum and, after the reshaping, to generate the vacuum anew.

In one advantageous embodiment, the base layer and/or the cover layer are made of a thermoplastic material with a textile structure. In this respect, for the padded layer arrangement, the choice of materials can be planned on the basis of the subsequent use. Occasionally, applying an additional laminating upper layer can thus be omitted.

It is furthermore advantageous if the base layer and/or the cover layer are provided with at least one further cover layer. Thus, as a finished component, the padded layer arrangement can be provided with the necessary surface features for the individual use.

The padded body protection element or padded protection body according to the invention comprises a padded layer arrangement according to the invention.

In the following figures, one embodiment of a padded layer arrangement according to the invention, a method for the production thereof and an example of use are sketched by way of example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective cut away view showing one embodiment of a padded layer arrangement;

FIG. 2 is a sectional view showing a hollow body formed within the padded layer arrangement;

FIG. 3 is a sectional view showing a possibility for producing the padded layer arrangement, illustrating one of individual method stages;

FIG. 4 is a sectional view showing a possibility for producing the padded layer arrangement, illustrating another of individual method stages;

FIG. 5 is a sectional view showing a possibility for producing the padded layer arrangement, illustrating another of individual method stages;

FIG. 6 is a sectional view showing a possibility for producing the padded layer arrangement, illustrating another of individual method stages;

FIG. 7 is a sectional view showing a possibility for producing the padded layer arrangement, illustrating another of individual method stages;

FIG. 8 is a sectional view showing a possibility for producing the padded layer arrangement, illustrating another of individual method stages; and

FIG. 9 is a schematic sectional view showing an application of the padded layer arrangement in a protective helmet.

### DESCRIPTION OF THE PREFERRED EMBODIMENTS

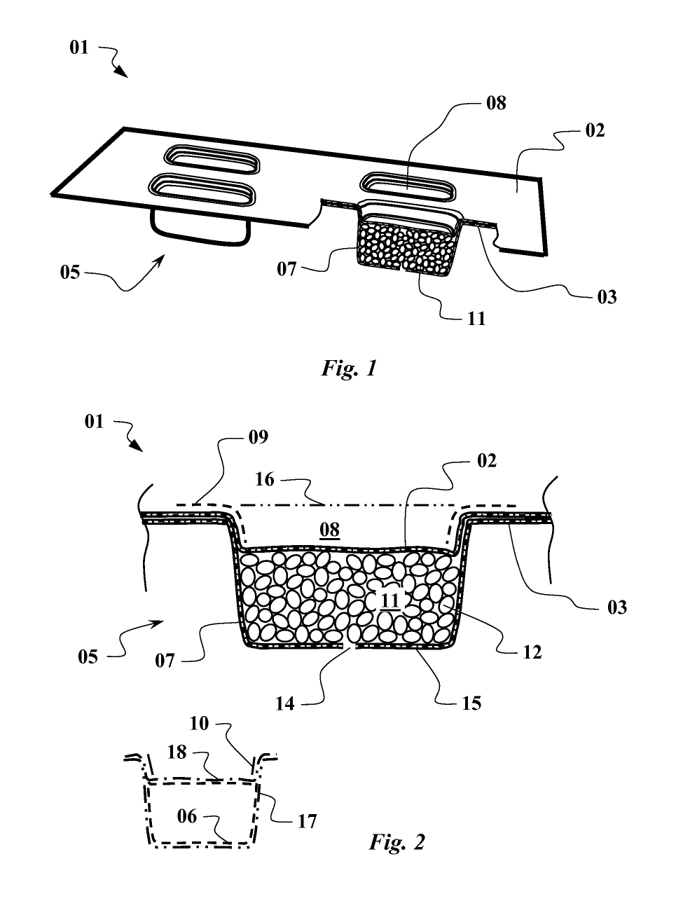

Referring to the drawings in particular, FIG. 1 shows a padded layer arrangement 01 with a base layer 03 and a cover layer 02, between which a plurality of hollow bodies 05 is formed, which are respectively formed by a base layer area 17 or a cover layer area 18 (as can be schematically seen in FIG. 2), which are connected to each other in a connection zone 09. In the cover layer area 18, a projection 08 is formed that extends into a pocket-shaped protuberance 07 of the base layer area 17. Within the hollow body 05, a shaped particle filling 11 is present. As can in particular be seen from FIG. 2, the pocket-shaped protuberance 07 and the projection 08 that extends into the same are formed in the same orientation and form a body casing 06 (schematically sketched) for the shaped particle filling 11. Within the connection zone 09, a joining connection is formed which ensures the permanent bonding between the base layer 03 and the cover layer 02 and thus stabilizes the body casing 06. The shaped particle filling 11 comprises a multiplicity of shaped particles 12, which rest against one another in a densely packed manner under pre-tension, which is applied onto the shaped particle filling 11 by means of the body casing 06.

In the area of a bottom wall 15 of the pocket-shaped protuberance 07, a bottom opening 14 is arranged, which, with the finished padded layer arrangement 01, enables a ventilation of the hollow bodies 05 and—as explained in the following—a deaeration of the hollow bodies when the padded layer arrangement 01 is produced.

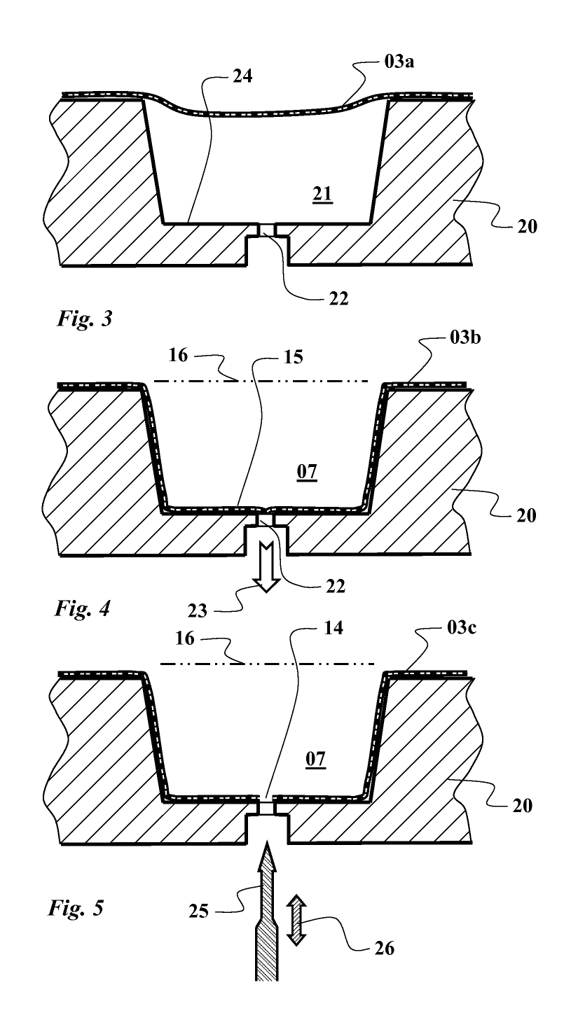

In the FIGS. 3 to 8, on the basis of the illustration of consecutive process stages, the production of the padded layer arrangement 01 illustrated in FIG. 1 is explained in more detail. FIG. 3 shows a base layer area 17 of the base layer 03, which is arranged on a mold plate 20 with a mold cavity 21. The mold cavity 21 is provided with a deaeration opening 22 in a mold cavity bottom 24.

Under the influence of an elevated temperature as well as by applying a vacuum 23 at the deaeration opening 22, a deep-drawing of the base layer 03 into the mold cavity 21 is effected, as illustrated in FIG. 4, in such a manner that the pocket-shaped protuberance 07 is formed and that the base layer 03 rests on the mold cavity bottom 24 with a bottom wall 15 of the pocket-shaped protuberance 07. By forming the protuberance 07, a filling opening 16 is formed in the base layer 03.

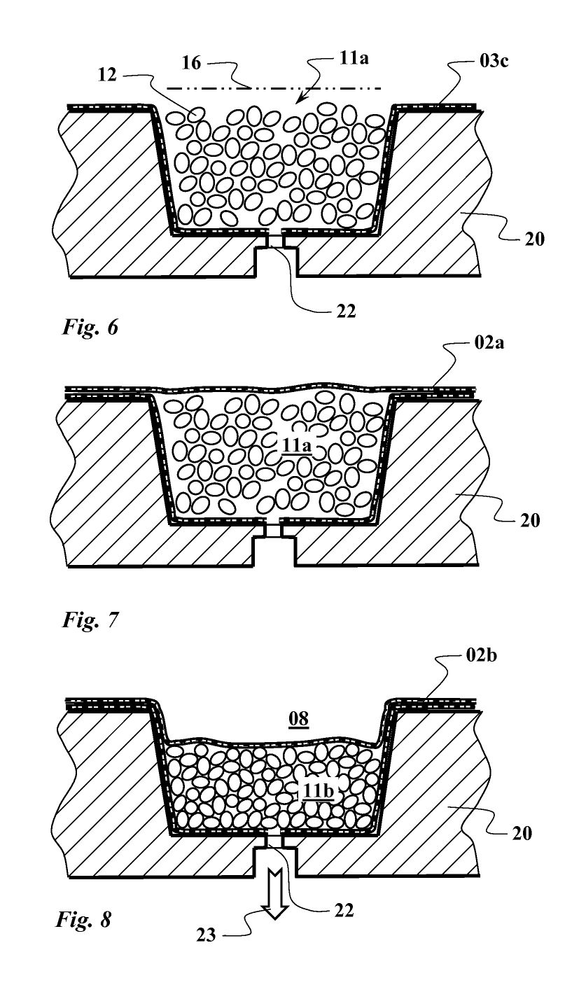

Subsequently, the bottom opening 14 is formed in the bottom wall 15, as shown by FIG. 5, by means of a thorn 25, and, via the filling opening 16 in the base layer area 17, the protuberance 07 is filled with shaped particles 12, which are inserted into the protuberance 07 as a loose bulk (FIG. 6).

After filling the protuberance 07, as illustrated in FIG. 7, the cover layer 02 with the cover layer area 18 is applied onto the base layer 03 and the base layer area 17, respectively, and is heated to deformation temperature by means of a heating device that is not illustrated in detail here.

By applying a vacuum 23 at the deaeration opening 22, as illustrated in FIG. 8, the cover layer area 18 of the cover layer 02, which has been heated to deformation temperature, is both drawn against an opening edge 10 of the filling opening 16 and against the shaped particle filling 11 that is received in the protuberance 07. Here, the cover layer area 18 follows the contours of the opening edge 10 and the shaped particle filling 11 while a joining connection is formed in the connection zone 09, wherein, while the projection 08 is formed in the cover layer area, a compression of the shaped particle filling 11 is effected.

The result of the method is the padded layer arrangement 01 illustrated in FIG. 1 with the projection 08 that extends into the pocket-shaped protuberance 07.

After the production of the padded layer arrangement, in another reshaping process, the padded layer arrangement can be reshaped for generating a desired contour that is stable in shape, which means for instance a bowl-shaped contour.

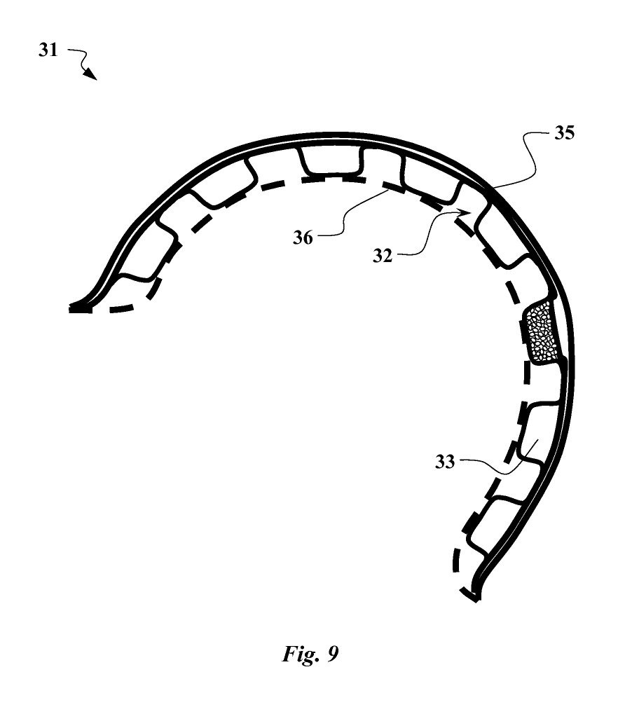

In FIG. 9, a protective helmet 31 is illustrated in a sectional view as one example for a potential application of the padded layer arrangement, with which a padded layer arrangement 32 with hollow bodies 33 is arranged between an outer shell 35 and an inner cover 36. Although it would be conceivable to use a padded layer arrangement 32 with a predominantly unstable structure or with a base and cover layer that can be flexibly bent and to achieve the desired contour of the padded layer arrangement only by the arrangement on the interior of the outer shell, it is advantageous for this exemplary embodiment if the cover and the base layers are thermally reshaped once again in the area surrounding the hollow bodies after the production of the padded layer arrangement 32 and thus, the best possible adaptation of the padded layer arrangement 32 to the outer shell 35 is effected.

While specific embodiments of the invention have been shown and described in detail to illustrate the application of the principles of the invention, it will be understood that the invention may be embodied otherwise without departing from such principles.

1. A method for the production of a padded layer arrangement for padded body protection with a plurality of hollow bodies, which are formed in a layer composite between a thermoplastically deformable base layer and a thermoplastically deformable cover layer, the method comprises the steps of:
forming a plurality of pocket-shaped protuberances within the base layer, by means of a vacuum and/or overpressure;
filling the pocket-shaped protuberances of the base layer with elastic shaped particles for forming a shaped particle filling;
arranging the cover layer on the base layer in such a manner that, for forming hollow spaces, filling openings of the pocket-shaped protuberances are covered by the cover layer; and
applying heat to the cover layer, which is arranged on the base layer, and applying a vacuum to the hollow spaces for forming projections in the cover layer that extend into the protuberance while simultaneously compressing the shaped particle filling which is arranged in the hollow spaces, and forming a joining connection in a connection zone that is formed at the opening edge of the pocket-shaped protuberance between the base layer and the cover layer.

2. The method according to claim 1, wherein for forming the pocket-shaped protuberances, the base layer is arranged on a mold plate with pocket-shaped mold cavities and subsequently, the vacuum and/or, on the upper side of the heated base layer, overpressure is applied to the mold cavities that are covered by the base layer, which has been heated to a deforming temperature.

3. The method according to claim 2, wherein for forming the projections of the cover layer that extend into the protuberance, the vacuum is applied to the hollow spaces, which are defined by the base layer being covered by the cover layer, via a bottom opening that is formed in a bottom wall of the protuberance.

4. The method according to claim 3, wherein for forming the bottom opening, a perforation of the bottom wall, which rests against a mold cavity bottom, is effected by means of a tool that is inserted into a deaeration opening of the mold plate.

5. The method according to claim 1, wherein during the vacuum application, the cover layer is covered from the rear by a gas-tight layer.

6. The method according to claim 1, wherein the application of temperature to the cover layer or to the layer that covers the cover layer is effected by means of a contact heater.

7. The method according to claim 1, wherein the application of temperature to the cover layer or to the gas-tight layer that covers the cover layer is effected by means of a radiation heater.

8. A padded layer arrangement for padded body protection the arrangement comprising:
a plurality of hollow bodies, which are formed in a layer composite between a thermoplastically deformable base layer and a thermoplastically deformable cover layer, the hollow bodies having a body casing that is formed by a base layer area and by a cover layer area, which are connected to each other via a joining connection in a connection zone that is circumferential in the plane of the layer composite, said connection zone forming an upper edge of a pocket-shaped protuberance of the base layer area; and
a shaped particle filling comprising a plurality of elastic shaped particles filing the hollow bodies, the shaped particles being compressed, in the cover layer area, and a projection being formed in the cover layer area that extends into the protuberance.

9. The padded layer arrangement according to claim 8, wherein the body casing has an opening.

10. The padded layer arrangement according to claim 9, wherein the opening is formed as a bottom opening in a bottom wall of the pocket-shaped protuberance.

11. The padded layer arrangement according to claim 8, wherein the base layer and/or the cover layer are formed from a thermoplastic material with a textile structure.

12. The padded layer arrangement according to claim 8, wherein the base layer and/or the cover layer are provided with at least one further cover layer.

13. A padded body protection element comprising:
a protection element part; and
a padded layer arrangement connected to the protection element part, the padded layer arrangement comprising:
a plurality of hollow bodies formed in a layer composite between a thermoplastically deformable base layer and a thermoplastically deformable cover layer, the hollow bodies having a body casing that is formed by a base layer area and by a cover layer area, which are connected to each other via a joining connection in a connection zone that is circumferential in the plane of the layer composite, the connection zone forming an upper edge of a pocket-shaped protuberance; and
shaped particles filling the hollow bodies, the shaped particles comprising a plurality of elastic shaped particles, the shaped particles being compressed, in the cover layer area, and a projection is formed in the cover layer area that extends into the protuberance.

14. A padded body protection element according to claim 13, wherein the body casing has an opening.

15. The padded body protection element according to claim 14, wherein the opening is formed as a bottom opening in a bottom wall of the pocket-shaped protuberance.

16. The padded body protection element according to claim 13, wherein the base layer and/or the cover layer are formed from a thermoplastic material with a textile structure.

17. The padded body protection element according to claim 13, wherein the base layer and/or the cover layer are provided with at least one further cover layer.

18. The padded body protection element according to claim 13, wherein the protection element part comprises at least one of an outer shell and an inner cover.
